(19) United States
(12) Patent Application Publication
(10) Pub. No.: US 2026/0168663 A1
(43) Pub. Date: Jun. 18, 2026

(54) HEAT DISSIPATOR WITH REPLACEABLE DECORATIVE PATTERN

(71) Applicant: SHENZHEN APALTEK CO., LTD., Shenzhen (CN)

(72) Inventors: Qineng XIAO, Dongguan (CN); Dagao ZHENG, Shenzhen (CN); Minrui CHEN, Shenzhen (CN)

(21) Appl. No.: 19/414,987

(22) Filed: Dec. 10, 2025

(30) Foreign Application Priority Data
Dec. 13, 2024 (CN) 2024230966640

(51) Int. Cl. F21V 29/56; F21V 17/10; F21V 29/506; F21W 121/00

(52) U.S. Cl. CPC F21V 29/56; F21V 17/105; F21V 29/506; F21W 2121/00

(57) ABSTRACT

A heat dissipator with a replaceable decorative pattern includes a heat dissipation main body and a decorative assembly. The heat dissipation main body includes an inner housing, a heat-absorbing base plate placed in the inner housing, an outer housing surrounding the inner housing and including a light exit port, a light-emitting circuit board arranged at the light exit port, and a light-transmissive cover fixed to the outer housing corresponding to the light exit port. The light-transmissive cover includes a first magnetic assembly. The decorative assembly includes a decorative block laser-engraved with a decorative pattern and an annular body fixed to the decorative block and provided with a second magnetic assembly. The decorative assembly is detachably arranged on the heat dissipation main body via magnetic attraction between the first and second magnetic assemblies, and the light-emitting circuit board emits light onto the decorative block via the light-transmissive cover.

### BACKGROUND OF THE DISCLOSURE

### Technical Field

The present disclosure relates to a heat dissipator, and more particularly, to a heat dissipator with a replaceable decorative pattern.

### Description of Related Art

For computers, especially gaming computers, light-emitting decorative components are often installed in the computer case to achieve lighting effects.

It is known in the related art to install light-emitting decorative components on a water-cooling head, allowing the water-cooling head to provide both water-cooling heat dissipation and lighting decoration effects.

However, a first deficiency of conventional light-emitting decorative components is that only a flat pattern is attached outside the light-emitting body, making the appearance monotonous and easily becoming visually unappealing. A second deficiency is that the conventional light-emitting decorative component is fixed to the water-cooling head; therefore, even if the user becomes tired of the original decorative component, the decorative component alone cannot be replaced, and the entire water-cooling head must be replaced, increasing the user's cost.

Therefore, how to overcome the above-mentioned deficiencies of the related art is a major issue that the inventor of the present disclosure urgently seeks to address.

### SUMMARY OF THE DISCLOSURE

An object of the present disclosure is to provide a heat dissipator with a replaceable decorative pattern.

To achieve the above object, the present disclosure provides a heat dissipator with a replaceable decorative pattern, including: a heat dissipation main body, including: an inner housing; a heat-absorbing base plate disposed in the inner housing; an outer housing disposed on the inner housing and surrounding the inner housing, the outer housing being provided with a light exit port; a light-emitting circuit board disposed in the inner housing corresponding to the light exit port; and a light-transmissive cover fixed to the outer housing corresponding to the light exit port, the light-transmissive cover being provided with a first magnetic assembly; and a decorative assembly, including: a decorative block, laser-engraved with at least one decorative pattern; and an annular body fixed to the decorative block and provided with a second magnetic assembly configured to be magnetically attached to the first magnetic assembly; wherein the decorative assembly is detachably disposed on the heat dissipation main body via magnetic attraction between the first magnetic assembly and the second magnetic assembly, and the light-emitting circuit board emits light onto the decorative block via the light-transmissive cover.

Compared with the related art, the present disclosure has the following effects: by laser-engraving a decorative pattern on the decorative assembly, a distinctive visual effect is produced when illuminated by the light-emitting circuit board, which does not become tiresome even after long-term viewing; and by respectively providing the first magnetic assembly and the second magnetic assembly on the heat dissipation main body and the decorative assembly, which are magnetically attachable to each other, the decorative assembly may be freely and conveniently replaced and is easy to mount.

### BRIEF DESCRIPTION OF THE DRAWINGS

FIG. 1 is a perspective exploded view of a decorative assembly of a heat dissipator of the present disclosure.

FIG. 2 is a perspective exploded view of an outer housing and a light-transmissive cover of the heat dissipator of the present disclosure.

FIG. 3 is a perspective exploded view of a heat dissipation main body of the heat dissipator of the present disclosure.

FIG. 4 is a perspective view of the heat dissipator of the present disclosure before the decorative assembly is assembled onto the heat dissipation main body.

FIG. 5 is a schematic cross-sectional view of the present disclosure corresponding to FIG. 4.

FIG. 6 is a perspective view of the heat dissipator of the present disclosure after the decorative assembly is assembled onto the heat dissipation main body.

FIG. 7 is a schematic cross-sectional view of the present disclosure corresponding to FIG. 6.

### DETAILED DESCRIPTION

The detailed description and technical content of the present disclosure are described below with reference to the drawings; however, the accompanying drawings are provided for reference and illustration only and are not intended to limit the present disclosure.

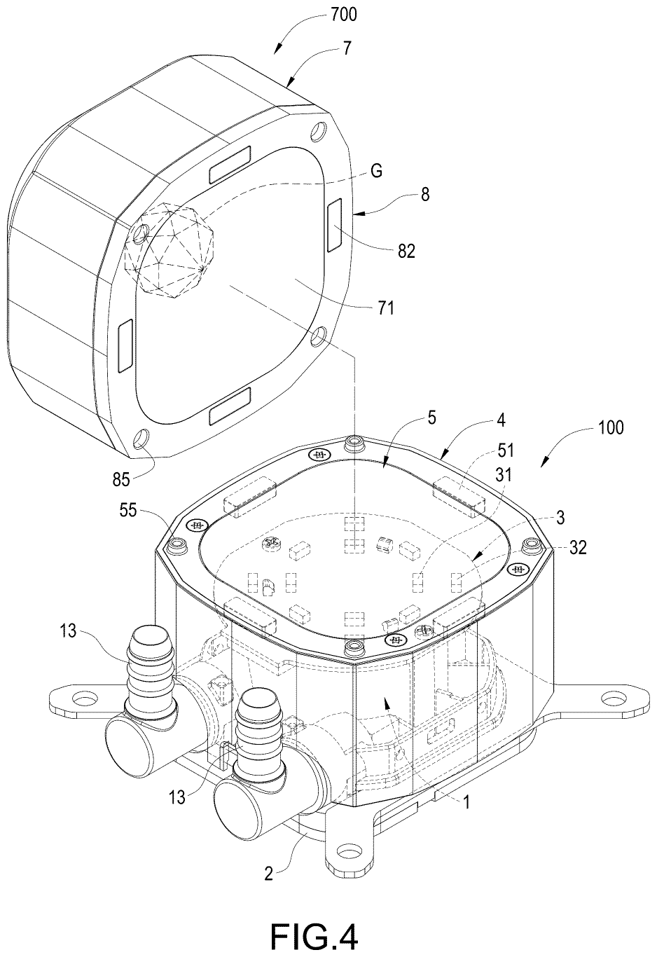

The present disclosure provides a heat dissipator with a replaceable decorative pattern, as shown in FIG. 4, which allows a user to conveniently replace the decorative assembly 700 having various decorative patterns G as needed.

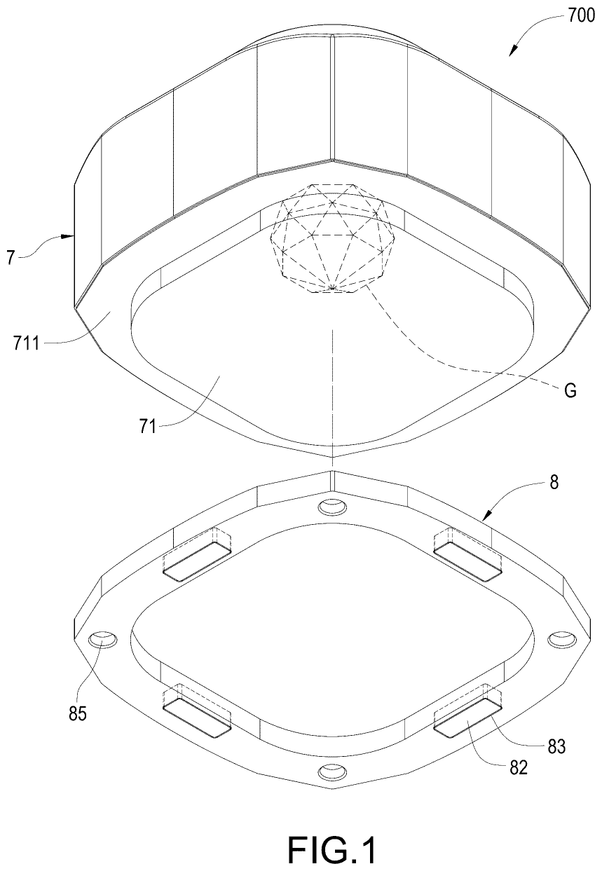

As shown in FIG. 1 to FIG. 5, the heat dissipator with a replaceable decorative pattern (abbreviation: heat dissipator) of the present disclosure includes: a heat dissipation main body 100 and a decorative assembly 700 for decoration.

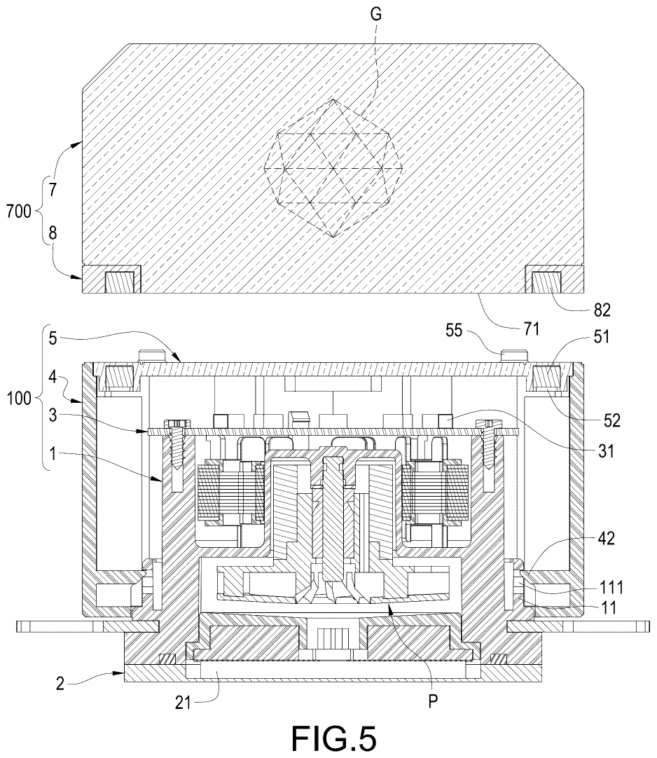

The heat dissipation main body 100 may be implemented using various types of heat-dissipating components. For example, it may be a water-cooling head with a built-in water pump body P as shown in FIG. 5, or a water-cooling head without a built-in water pump body (not illustrated). The present disclosure is not limited thereto, and in this embodiment, a water-cooling head with the built-in water pump body P is used as an example for description.

The heat dissipation main body 100 includes an inner housing 1, a heat-absorbing base plate 2, a light-emitting circuit board 3, an outer housing 4, and a light-transmissive cover 5.

As described above, a water pump body P is built into the inner housing 1 and connected to two water connection joints 13. The inner housing 1 has an upper opening and a lower opening (both not labeled with reference numerals, see FIG. 5) opposite to each other. The light-emitting circuit board 3 is configured with a plurality of light-emitting elements and is disposed in the inner housing 1 corresponding to the upper opening position. The heat-absorbing base plate 2 is provided with a heat-dissipating fin set 21 (see FIG. 5) and is disposed in the inner housing 1 corresponding to the lower opening position. In addition, a surrounding wall 11 may be disposed on the periphery of the inner housing 1, and the surrounding wall 11 is provided with a plurality of latching holes 111.

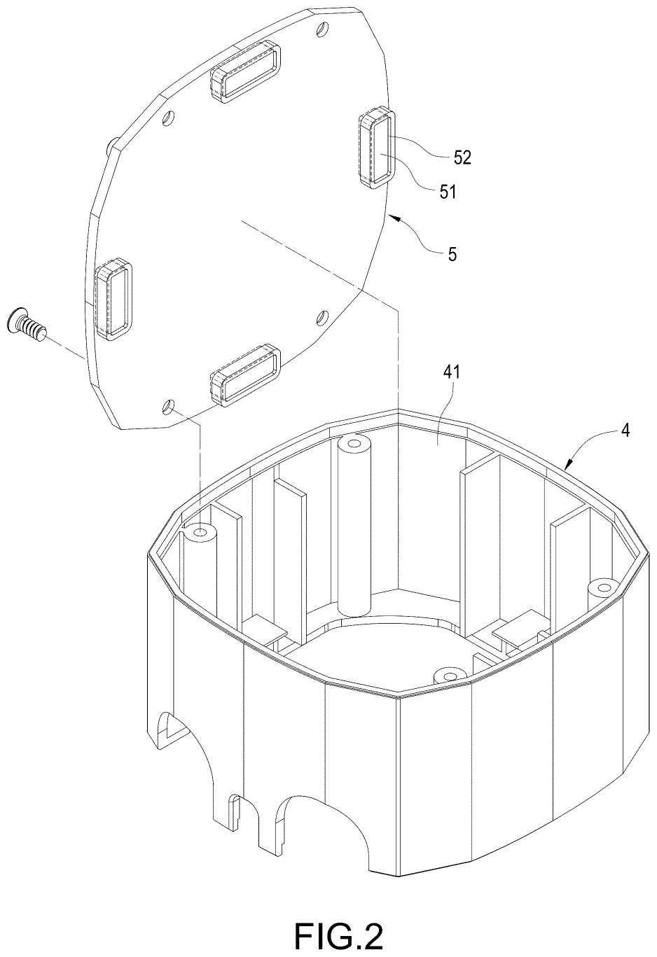

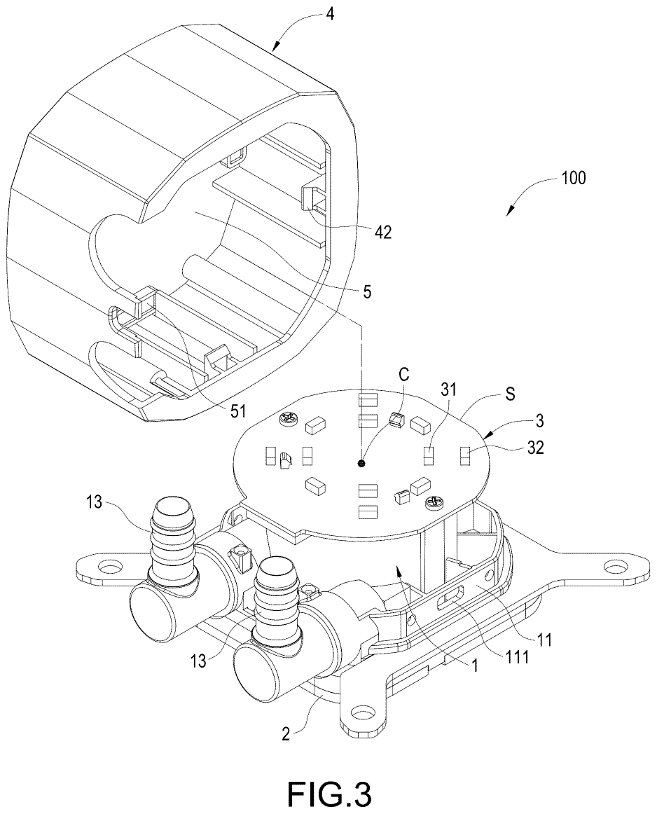

As shown in FIG. 2, the outer housing 4 has a light exit port 41 and a bottom opening (not labeled) opposite to each other. When the outer housing 4 is disposed on the inner housing 1 in a manner surrounding the inner housing 1, the upper opening of the inner housing 1 corresponds to the light exit port 41 of the outer housing 4, so that the surface of the light-emitting circuit board 3 provided with the light-emitting elements faces the light exit port 41 as shown in FIG. 5, allowing the light emitted by the light-emitting circuit board 3 to exit through the light exit port 41. As shown in FIG. 3, the outer housing 4 is provided with a plurality of latching protrusions 42 protruding from the inner edge corresponding to its bottom opening, so that each latching protrusion 42 is engaged with a corresponding one of the latching holes 111 as shown in FIG. 5. In this way, the outer housing 4 is disposed on and surrounding the inner housing 1. In other embodiments not shown in the drawings, the arrangement of the latching protrusions 42 and the latching holes 111 may be reversed.

The light-transmissive cover 5 is fixed to the outer housing 4 at a position corresponding to the light exit port 41, so that the light-transmissive cover 5 closes the light exit port 41. At this time, as shown in FIG. 5, the light-transmissive cover 5 and the light-emitting circuit board 3 face each other with a spacing therebetween. As shown in FIG. 2 and FIG. 4, a plurality of first magnetic elements 51 are further provided at the periphery of the light-transmissive cover 5, and these first magnetic elements 51 jointly form a first magnetic assembly (not labeled). Specifically, as shown in FIG. 2 and FIG. 5, the light-transmissive cover 5 is provided with a plurality of receiving grooves 52, and each first magnetic element 51 is correspondingly embedded in a respective one of the receiving grooves 52.

The decorative assembly 700 is configured to be detachably disposed on the heat dissipation main body 100, and includes a decorative block 7 and an annular body 8.

The decorative block 7 is a three-dimensional block and may be a transparent block, a light-transmitting block, or an opaque block. In this embodiment, a transparent block (such as a transparent acrylic block) is used as an example. Accordingly, the decorative block 7 has a light incident surface 71 and a plurality of light-emitting surfaces (symbols not labeled). In addition, the decorative block 7 is laser-engraved with at least one decorative pattern G. The decorative pattern G may be three-dimensional text, symbols, graphics, or any combination thereof, and is not limited by the present disclosure. In one example embodiment, the light incident surface 71 is recessed to form an annular groove 711.

The annular body 8 is fixed to the decorative block 7 corresponding to the annular groove 711. In one example embodiment, the annular body 8, after being fixed, is flush with the light incident surface 71. The annular body 8 is further provided with a plurality of second magnetic elements 82 spaced apart from each other. These second magnetic elements 82 jointly form a second magnetic assembly (not labeled). Specifically, as shown in FIG. 1 and FIG. 5, the annular body 8 is provided with a plurality of embedding grooves 83, and each second magnetic element 82 is embedded in a respective one of the embedding grooves 83.

It should be noted that the first magnetic elements 51 and the second magnetic elements 82 are configured to be magnetically attachable to each other. The first magnetic elements 51 and the second magnetic elements 82 may both be magnets, or one may be a magnet and the other a magnetically attractable metal. The annular body 8 may be an O-shaped annular body, a C-shaped annular body, or a pair of C-shaped annular bodies. The present disclosure does not limit this, and in this embodiment, an O-shaped annular body is taken as an example for description. In addition, the annular body 8 may be any non-magnetically conductive object, for example, an aluminum ring, but is not limited thereto.

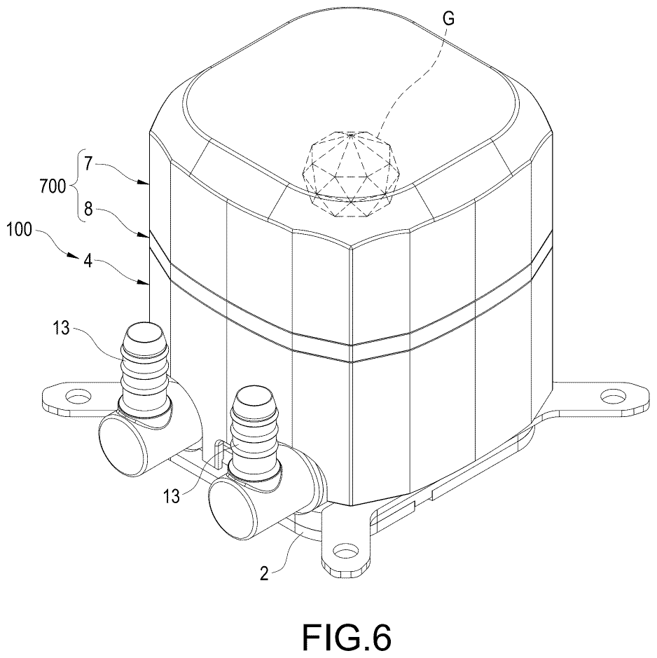

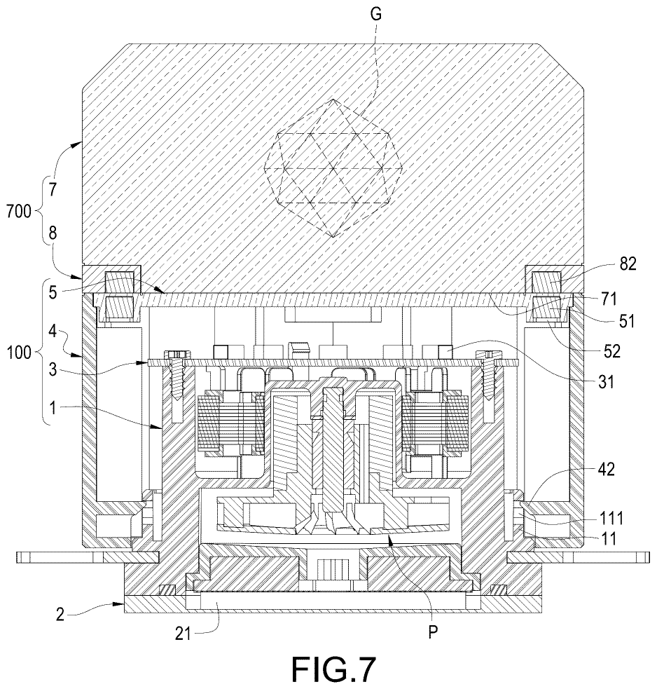

Accordingly, as shown in FIG. 4 to FIG. 7, the user only needs to place the decorative assembly 700, which is laser-engraved with the three-dimensional decorative pattern G, with its light incident surface 71 corresponding to the light-transmissive cover 5 of the heat dissipation main body 100, so that the first magnetic assembly and the second magnetic assembly become magnetically attached to each other. In this manner, the decorative assembly 700 is detachably disposed on the heat dissipation main body 100 by magnetic attraction, and the light emitted from the light-emitting circuit board 3 irradiates the decorative block 7 and its decorative pattern G through the light-transmissive cover 5. This not only produces a lighting effect but also highlights the decorative pattern G. Because the decorative pattern G is formed by laser engraving, a visual appearance remains appealing even after prolonged viewing. In addition, the user may replace decorative assemblies 700 having different decorative patterns G as needed. Only the decorative assembly 700 needs to be replaced, without replacing the heat dissipation main body 100, which reduces cost. Furthermore, because magnetic attraction is used to dispose the decorative assembly 700, replacement is also convenient.

It should be noted that a spacing distance is present between the surface of the light-emitting circuit board 3 on which the light-emitting elements are disposed and the light-transmissive cover 5, as shown in FIG. 5. If insufficient light uniformity occurs due to the spacing distance being too short, the light-emitting elements may be configured to emit light from the side instead of directly toward the light-transmissive cover 5. In this way, light spots that would otherwise appear on the light-transmissive cover 5 due to the short spacing distance and affect visual appearance may be avoided. Details are described in the following paragraph.

As shown in FIG. 3 in conjunction with FIG. 5, the light-emitting circuit board 3 has a board periphery S and defines a central portion C located at approximately the center of the light-emitting circuit board 3, such that the board periphery S surrounds the central portion C. The light-emitting elements disposed on the light-emitting circuit board 3 include a plurality of first light-emitting elements 31 and a plurality of second light-emitting elements 32. All the first light-emitting elements 31 emit light toward the central portion C (side-emission toward the central portion C), and all the second light-emitting elements 32 emit light toward the board periphery S (side-emission toward the board periphery S). Therefore, because none of the first light-emitting elements 31 and the second light-emitting elements 32 directly emit light toward the light-transmissive cover 5, but instead emit light from the side, uniform light distribution may still be achieved even when the spacing distance is relatively short.

In addition, to provide a positioning effect after the decorative assembly 700 is magnetically attached, as shown in FIG. 1 and FIG. 4, a plurality of positioning posts 55 may protrude from the outer surface of the light-transmissive cover 5, and a plurality of positioning holes 85 may be recessed in the side of the annular body 8 facing the light-transmissive cover 5 corresponding to each positioning post 55. Accordingly, when the decorative assembly 700 is magnetically attached, each positioning post 55 is inserted into a corresponding positioning hole 85, allowing the decorative assembly 700 to be positioned on the heat dissipation main body 100 without lateral displacement. In other embodiments not shown in the drawings, the arrangement of the positioning posts 55 and the positioning holes 85 may be reversed.

In summary, the heat dissipator with a replaceable decorative pattern of the present disclosure achieves the intended use and effects and addresses the deficiencies of the related art, and therefore, a patent application is filed.

The foregoing description merely illustrates some embodiments of the present disclosure and is not intended to limit the scope of the present disclosure. Any equivalent structural modifications made based on the contents of the specification and the drawings shall fall within the scope of the present disclosure, as defined by the appended claims.

What is claimed is:

1. A heat dissipator with a replaceable decorative pattern, comprising:
a heat dissipation main body, comprising:
an inner housing;
a heat-absorbing base plate disposed in the inner housing;
an outer housing disposed on the inner housing and surrounding the inner housing, the outer housing being provided with a light exit port;
a light-emitting circuit board disposed in the inner housing corresponding to the light exit port; and
a light-transmissive cover fixed to the outer housing corresponding to the light exit port, the light-transmissive cover being provided with a first magnetic assembly; and
a decorative assembly, comprising:
a decorative block, laser-engraved with at least one decorative pattern; and
an annular body fixed to the decorative block and provided with a second magnetic assembly configured to be magnetically attached to the first magnetic assembly;
wherein the decorative assembly is detachably disposed on the heat dissipation main body via magnetic attraction between the first magnetic assembly and the second magnetic assembly, and the light-emitting circuit board emits light onto the decorative block via the light-transmissive cover.

2. The heat dissipator with the replaceable decorative pattern as claimed in claim 1, wherein a water pump body is disposed within the inner housing, and the inner housing is provided with two water connection joints.

3. The heat dissipator with the replaceable decorative pattern as claimed in claim 1, wherein a surrounding wall is disposed on a periphery of the inner housing, and the outer housing is latched to the surrounding wall.

4. The heat dissipator with the replaceable decorative pattern as claimed in claim 1, wherein the inner housing is provided with two openings, and the light-emitting circuit board and the heat-absorbing base plate are disposed in the inner housing and respectively arranged corresponding to the two openings.

5. The heat dissipator with the replaceable decorative pattern as claimed in claim 1, wherein the light-emitting circuit board comprises a board periphery and defines a central portion, the board periphery surrounds the central portion, the light-emitting circuit board comprises a plurality of first light-emitting elements and a plurality of second light-emitting elements, and the plurality of first light-emitting elements and the plurality of second light-emitting elements respectively emit light toward the central portion and the board periphery.

6. The heat dissipator with the replaceable decorative pattern as claimed in claim 1, wherein the decorative block comprises a light incident surface, the light incident surface is disposed corresponding to the light-transmissive cover, an annular groove is recessed into the light incident surface, and the annular body is fitted into the annular groove and fixed to the decorative block.

7. The heat dissipator with the replaceable decorative pattern as claimed in claim 1, wherein a plurality of positioning posts protrude from the light-transmissive cover, and a plurality of positioning holes are recessed into the annular body and respectively correspond to the plurality of positioning posts.
